(19) United States
(12) Patent Application Publication
(10) Pub. No.: US 2016/0240104 A1
(43) Pub. Date: Aug. 18, 2016

(54) Method for Numerically Measuring Mathematical Fitness

(71) Applicant: BrainQuake Inc, Petaluma, CA (US)

(72) Inventor: Keith James Devlin, Petaluma, CA (US)

(21) Appl. No.: 15/044,641

(22) Filed: Feb. 16, 2016

Related U.S. Application Data
(60) Provisional application No. 62/116,707, filed on Feb. 16, 2015.

(51) Int. Cl. G09B 23/02

(52) U.S. Cl. CPC G09B 23/02

(57) ABSTRACT

A method for measuring the mathematical fitness of a plurality of user accounts. The method includes prompting an arbitrary account from the user accounts to solve a mathematical problem through a corresponding personal computing (PC) device. After receiving answering data, an external server compares the answering data against each of a plurality of solutions to identify a matching solution. Throughout this method, the external server monitors the PC device and measures a performance score, a persistence score, and records a user solving procedure. The user solving procedure is then compared to a usage frequency data for a plurality of known solving procedures in order to measure a creativity score. The arbitrary account can then view the performance score, the persistence score, and the creativity score in the form of a performance portfolio for the mathematical problem. This is repeated for each user account for a plurality of mathematical problems.

The current application claims a priority to the U.S. Provisional Patent application Ser. No. 62/116,707 filed on Feb. 16, 2015.

### FIELD OF THE INVENTION

The present invention relates generally to the field of testing and measuring cognitive mathematical ability. The present invention is a method and system for numerically measuring mathematical fitness through the measurement of a performance metric, a persistence metric, and a creativity metric based on a user solving an open-ended mathematical problem.

### BACKGROUND OF THE INVENTION

For most of the history of mathematics, the primary focus was on computation. Successful citizenry required mastery of a set of basic computation skills. Even in jobs that required higher mathematics, such as algebra, the focus was on computation. Learning mathematics consisted largely of practice to mastery of a set of standard procedures for carrying out numeral or symbolic calculations. Testing and credentialing of mathematical mastery asked candidates to solve, under controlled conditions, a number of problems using those standard procedures. But with today's ubiquitous availability of cheap, powerful computational devices, the need for mathematical skills has changed. In the 21st Century, the crucial ability is to make effective use of that computational resource. The key ability has transitioned from mastery of procedures to creative problem solving—frequently referred to as mathematical thinking. Testing and credentialing has to focus on that newly important ability. The present invention is a novel method for measuring mathematical fitness, which is the capacity to engage in productive mathematical thinking.

Currently, automated testing methods only check answers to problems, not how the problems were solved. Moreover, in order to implement at scale, the problems used are overwhelmingly presented in a multiple-choice format. Selecting one from a small number of presented possible answers as a solution to a problem is not the same as solving the problem when the problem is presented with no indication of what the solution may be. These factors mean those problems are not truly open-ended and do not assess the thinking that led to the solution. Therefore, new metrics and new testing methods are required. Since the essence of 21st Century mathematical thinking is the ability to solve a novel problem that does not easily fit a standard template, the key capacity to be measured is mathematical fitness.

The present invention measures mathematical fitness by means of three factors: performance (embodying completion, correctness and efficiency), persistence, and creativity.

The best, scalable, current assessment methods attempt to measure all three aspects of mathematical problem solving but the use of multiple-choice questions is a significant limitation and the notion of “creativity” they measure is simplistic. The current methods are used because, given currently available assessment technology, they are the only ones that can be implemented at scale. The present invention provides a method to measure all three factors at scale through the application of novel assessment technology.

### BRIEF DESCRIPTION OF THE DRAWINGS

FIG. 1 is a system diagram of the present invention.

FIG. 2 is a flowchart describing the overall process of the present invention.

FIG. 3 is a flowchart describing a process for deriving a performance score of the arbitrary account.

FIG. 4 is a flowchart describing how the performance score is derived, specifically in relation to the solving procedure used by the arbitrary account.

FIG. 5 is a flowchart describing how a total number of steps of the solving procedure affects the performance score.

FIG. 6 is a flowchart describing a process for deriving a persistence score of the arbitrary account.

FIG. 7 is a flowchart describing one factor which determines the persistence score, a total repetition number.

FIG. 8 is a flowchart describing another factor which determines the persistence score, a total time duration for the repetitions.

FIG. 9 is a flowchart describing the overall process of the present invention being executed for each user account.

FIG. 10 is a flowchart describing how the creativity score of the arbitrary account is measured.

FIG. 11 is a flowchart describing the overall process of the present invention being executed for a plurality of mathematical problems

FIG. 12 is a flowchart describing how the comprehensive performance score is compiled.

FIG. 13 is a flowchart describing how the comprehensive persistence score is compiled.

FIG. 14 is a flowchart describing how the comprehensive creativity score is compiled.

FIG. 15 is a flowchart describing the overall process of the present invention being executed for the plurality of user accounts for the plurality of mathematical problems.

### DETAIL DESCRIPTIONS OF THE INVENTION

All illustrations of the drawings are for the purpose of describing selected versions of the present invention and are not intended to limit the scope of the present invention.

The present invention relates to the field of cognitive testing. More specifically, the present invention is a method and system for numerically measuring mathematical fitness in order to quantify the creative solving ability of an individual. This is achieved through the use of an extended test interaction where the individual is asked to solve a series of open-ended problems or puzzles through a computing device. Two important aspects about this assessment is that there are no multiple-choice questions and that the individual must carry out all key steps of the problem, or puzzle, with the computing device. This allows the present invention to monitor and track every step that the individual goes through in order to solve the problem or puzzle; repeating the procedure for a variety of problems and a number of individuals to yield raw descriptive information. The raw descriptive information is used to measure a performance score, a persistence score, and a creativity score for each individual; which are then used to calculate an overall mathematical intelligence score for each individual. It is important to implement the present invention on a large group of people. A significant sample size ensures that significant, reliable, and more fine-grained data is obtained that not only reflects the cognitive ability of each individual but also can be used to make inferences and predictions about a corresponding population.

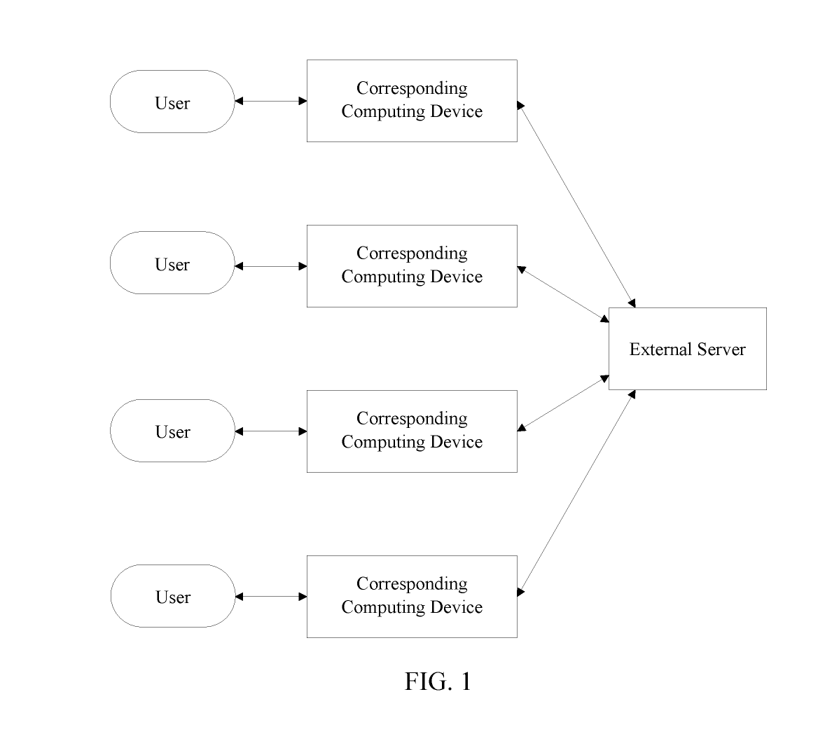

The present invention includes a method and a system in order to test and assess the mathematical cognitive ability of a plurality of user accounts. The plurality of user accounts represent a group of individuals; preferably a group of individuals with equal or similar educational levels such that an equal comparison can be made between them. The present invention is described in relation to an arbitrary account, wherein the arbitrary account represents any one of the user accounts. The method is executed by the system in the form of a software application. In particular, referring to FIG. 1, the system includes an at least one external server and a corresponding personal computer (PC) device for each of the user accounts (Step A). The external server provides significant amounts of data storage to be used by the present invention, which is a necessity when collecting and processing vast amounts of data. The PC device provides a medium for administering the problem or puzzle and recording/monitoring the procedure used to solve said problem or puzzle. The corresponding PC device for each of the user accounts is communicably coupled to the external server, preferably through the Internet. Types of PC devices that may be used for the system includes, but is not limited to, a desktop computer, a laptop computer, a smartphone, and a tablet computer.

A variety of mathematical problems may be used for the present invention in order to suit the education level of the plurality of user accounts. In alternative embodiments of the present invention, the mathematical problem is replaced by a puzzle that may or may not represent a mathematical problem. The ideal problem is an open-ended problem that can be solved a multitude of ways with each way being associated with a correct answer. Furthermore, the ideal problem also requires the individual to interact with the PC device in a step-by-step fashion such that each step may be monitored and recorded.

In general, prior to implementation, the present invention must first be provided with a plurality of mathematical problems, wherein each of the mathematical problems is associated with a plurality of solutions and a plurality of known solving procedures (Step B). A solution is a number, symbol, word, or phrase that is the answer to the associated mathematical problem. A known solving procedure is the entire sequence of steps that need to be taken to reach the solution for the associated mathematical problem. The present invention is further provided with usage frequency data for the plurality of known solving procedure (Step C). The usage frequency data depicts the number of times each of the plurality of known solving procedures is used. During the execution of the present invention, the usage frequency data is continuously updated based on the user solving procedures of each of the user accounts. In alternative embodiments, the usage frequency data is obtained from external testing or other external origins. The plurality of known solving procedures and the usage frequency data are stored on the external server.

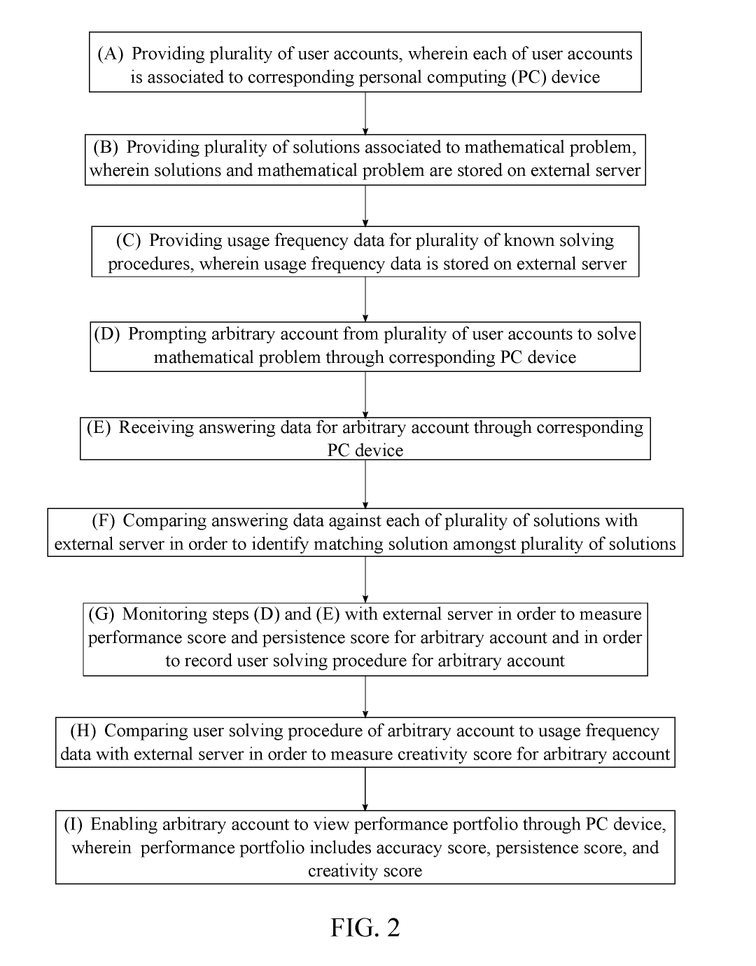

Referring to FIG. 2, the overall process for the present invention are the steps that need to be taken in order to measure the performance score, the persistence score, and the creativity score of an arbitrary account from the plurality of user accounts for a mathematical problem. The arbitrary account represents any one of the user accounts, and the mathematical problem represents one of the mathematical problems. The overall process begins by prompting the arbitrary account to solve the mathematical problem through the corresponding PC device (Step D). This involves the arbitrary account interacting with the corresponding PC device through user interface components. Types of user interface components include, but are not limited to, a mouse, a keyboard, a touchscreen, a joystick, a controller, and a display screen. These interactions are registered and received as answering data through the corresponding PC device (Step E) to be saved by on the external server. Answering data includes any of the inputs registered by the corresponding PC device through the user interface components. Next, the external server compares the answering data against each of the plurality of solutions in order to identify a matching solution amongst the plurality of solutions (Step F). This determines if the arbitrary account solved the mathematical problem correctly.

Continuing the overall process, the external server continuously monitors step D and step E in order to measure the performance score and the persistence score for the arbitrary account as well as record a user solving procedure for the arbitrary account (Step G). The performance score reflects the degree to which the mathematical problem is solved, a variety of factors may be used to determine this metric. Since performance score is, by and large, what current assessment methods primarily measure, there are many procedures and algorithms that can be used as a basis for the computation of the performance score. The persistence score is a measure of the degree to which the arbitrary account will continue to work on the mathematical problem, trying different approaches, until one of the solutions is reached or else adequate progress is made. Next, the external server measures the creativity score for the arbitrary account by comparing the user solving procedure of the arbitrary account to the usage frequency data (Step H). The creativity score measures the degree to which the answering data of the arbitrary account shows novelty, described in further detail below. Finally, through the PC device, the present invention enables the arbitrary account to view a performance portfolio (Step I) in order to provide performance feedback to the arbitrary account. The performance portfolio includes the performance score, the persistence score, and the creativity score for the arbitrary account in regards to the mathematical problem.

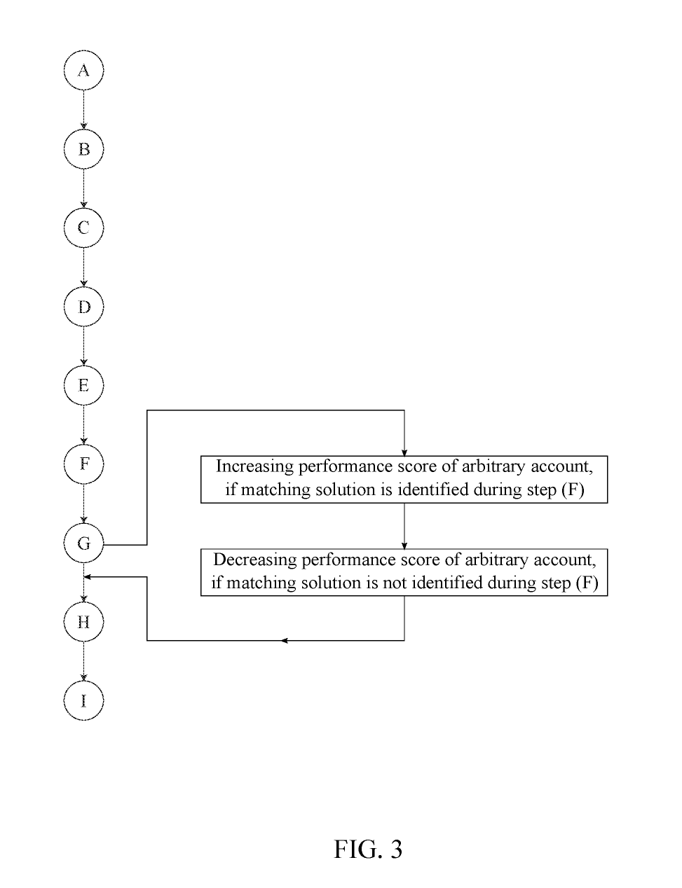

The performance score quantifies the degree of correctness of the arbitrary account for the mathematical problem. Referring to FIG. 3, one factor that may play into the performance score is the correctness of the answering data submitted by the arbitrary account. More specifically, if the matching solution is identified during Step F, then the performance score is increased for the arbitrary account. Alternatively, if the matching solution is not identified during Step F, then the performance score is decreased for the arbitrary account. The numerical value that the performance score is raised to or lowered to is predefined by a proctor or an administrative entity.

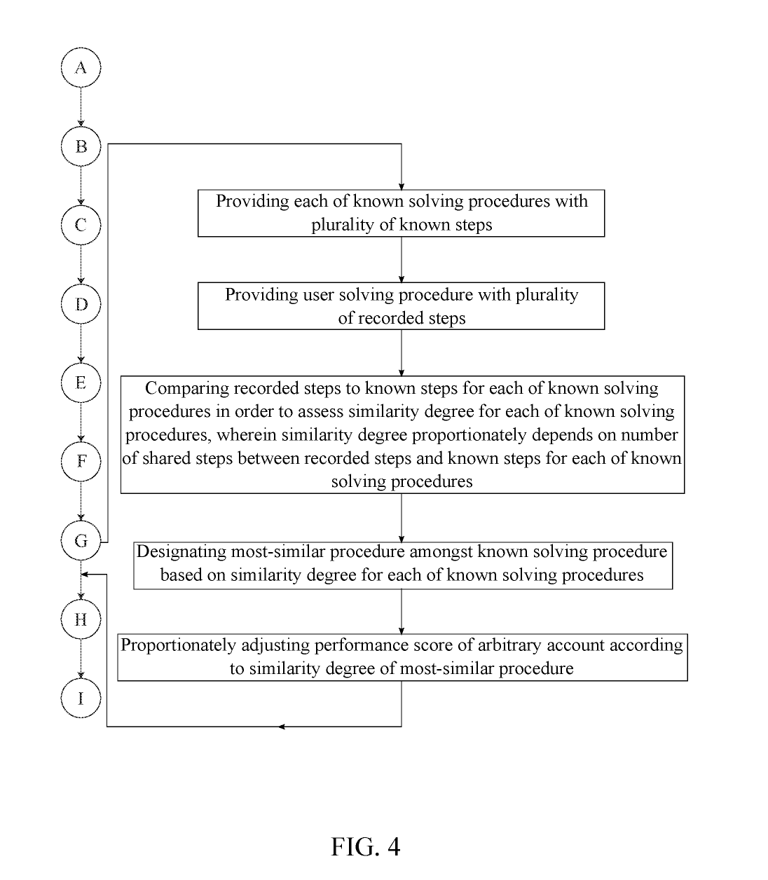

Referring to FIG. 4, each of the known solving procedures includes a plurality of known steps and, in a similar fashion, the user solving procedure includes a plurality of recorded steps. In the case that the matching solution is not found, the recorded steps are compared against the known steps for each of the known solving procedures in order to assess a similarity degree for each of the known solving procedures. The similarity degree proportionately depends on a number of shared steps between the recorded steps and the known steps for each of the known solving procedures. A most-similar procedure amongst the known solving procedures is designated based on the similarity degree for each of the known solving procedures; the solving procedure with the most shared steps. The performance score of the arbitrary account is then proportionately adjusted according to the similarity degree of the most-similar procedure. The higher the similarity degree affects the performance score more.

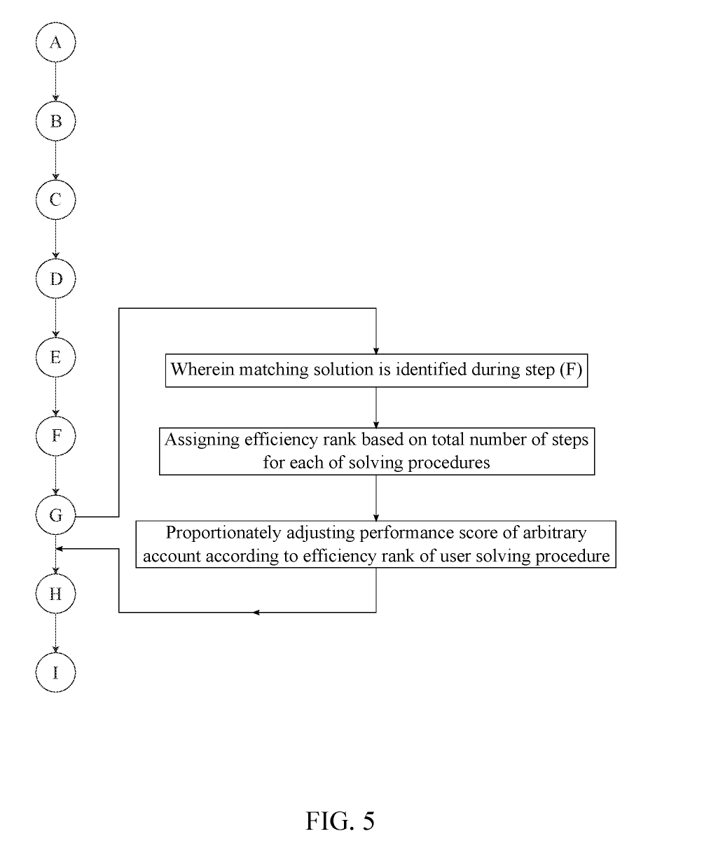

Referring to FIG. 5, another factor that may play into the performance score is the efficiency of the user solving procedure. One way this may be accomplished is by assigning an efficiency rank for each of the known solving procedures based on a total number of steps taken. The fewer total number of steps results in a higher the efficiency rank; and alternatively, the more total number of steps results in a lower the efficiency rank. This factor applies only if the matching solution is identified during Step F. The performance score for the arbitrary account is proportionately adjusted according to the efficiency rank of the user solving procedure. The performance score is designed to benefit/reward the arbitrary account if he or she solves the mathematical problem within the fewest number of steps. If the matching solution is not identified during Step F, then partial credit is given based on the correct portion of the user solving procedure.

The persistence score quantifies the effort and time that the arbitrary account puts into solving or attempting to solve the mathematical problem. This metric is possible to measure because the present invention is centered around open-ended problems that require several steps/stages to obtain the solution. In one embodiment of the present invention, in order to measure the persistence score, the arbitrary account is provided with a notification after Step F which indicates if he or she has identified one of the solutions. The notification allows the present invention to quantify the number attempts that the arbitrary account takes before either giving up or solving the mathematical problem.

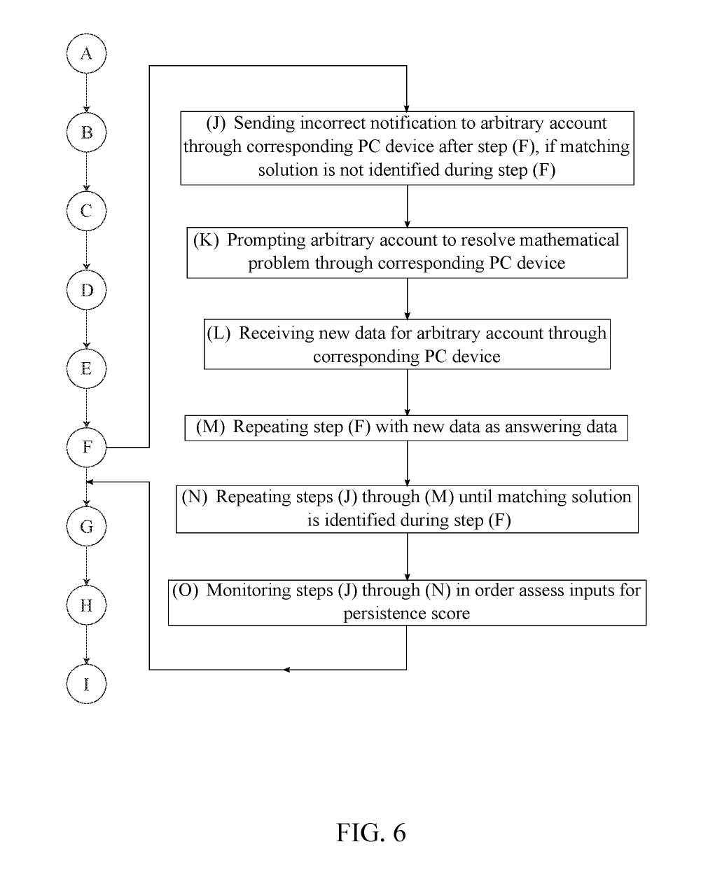

More specifically, referring to FIG. 6, the process includes sending an incorrect notification to the arbitrary account through the corresponding PC device after Step F, if the matching solution is not identified during Step F (Step J). The incorrect notification simply states that the submitted answering data does not include one of the solutions; it is important that the incorrect notification does not include any hints to finding a solution because this will skew the persistence score. The corresponding PC device then prompts the arbitrary account to resolve the mathematical problem (Step K), either restarting the whole process or prompting the arbitrary account for another answer to the mathematical problem. Then the corresponding PC device receives new data for the arbitrary account as the arbitrary account attempts to solve the mathematical problem again (Step L). The new data is stored on and analyzed by the external server. More specifically, the external server repeats Step F with the new data as the answering data in order to determine if one of the solutions is present in the new data. Step J through Step M are repeated until the matching solution is identified during Step F or the arbitrary account chooses to give up and skip the mathematical problem. The present invention monitors Step J through N in order to identify and assess inputs for the persistence score (Step O).

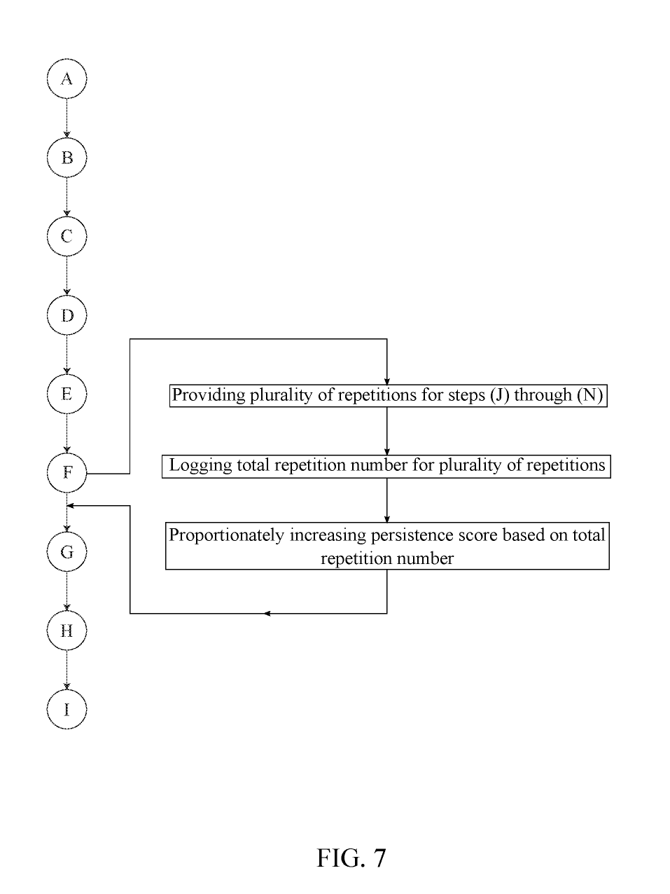

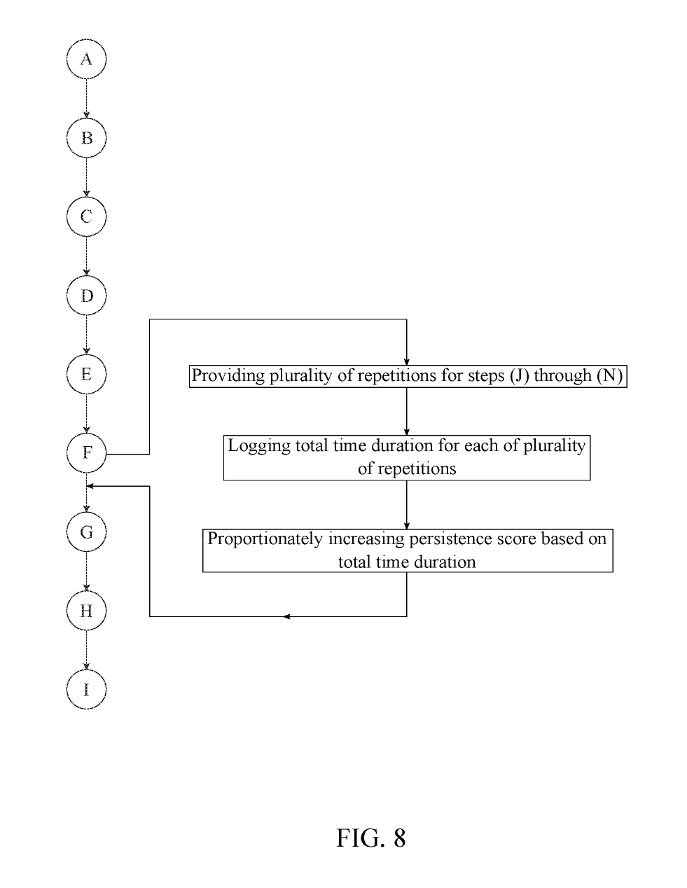

Referring to FIG. 7, one kind of input for the persistence score is a total repetition number for a plurality of repetitions, wherein a single repetition from the plurality of repetitions is defined by Step J though Step N. Essentially, the total repetition number is the number of attempts that the arbitrary account tried before reaching one of the solutions or giving up. The total repetition number for the plurality of repetitions is logged and then used to proportionately increase the persistence score. A greater total repetition number affects the persistence score more significantly. In addition, referring to FIG. 8, the present invention also logs a total time duration for each of the plurality of repetitions as the number of attempts does not fully depict the persistence of the arbitrary account. The total time duration is used to proportionately increase the persistence score; a longer total time duration affects persistence score more significantly. The present invention is designed to reward an individual who attempts the mathematical problem a large number of times and for an extended amount of time through the persistence score.

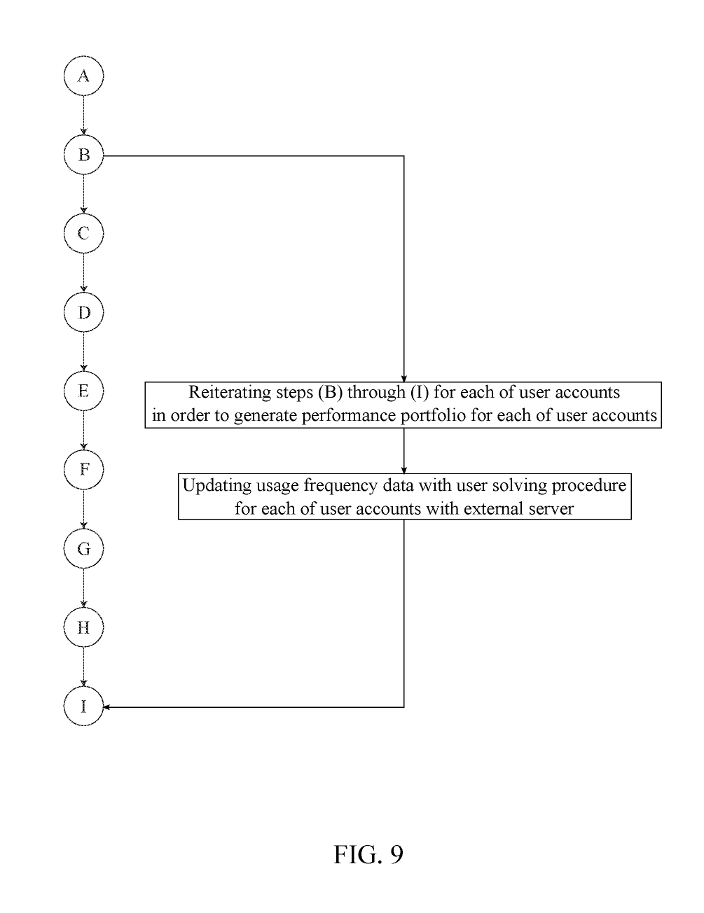

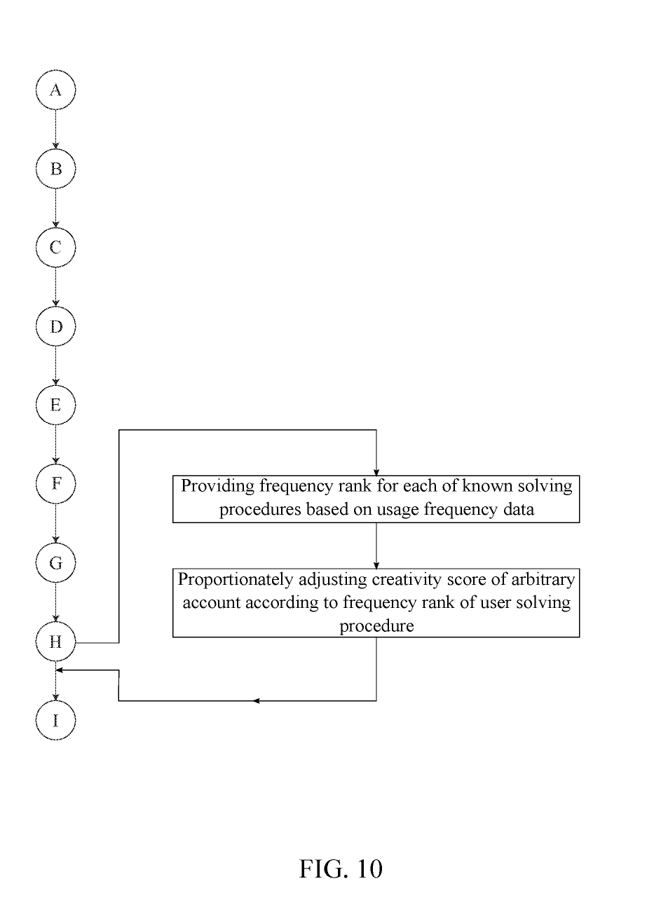

The creativity score reflects the degree of novelty shown by the arbitrary account while solving the mathematical problem. The creativity score depends on which of the plurality of known solving procedures is used to solve the mathematical problem. In order to measure the creativity score, the present invention is provided with the usage frequency data for the plurality of known solving procedures. This includes data on how often each of the plurality of known solving procedures is used to solve the mathematical problem. A variety of means may be used to obtain the usage frequency data. Referring to FIG. 9, one particular way includes reiterating Step B through Step I for each of the user accounts in order to generate the performance portfolio for each of the user accounts. Throughout this process, the usage frequency data is continuously updated with the user solving procedure for each of the user accounts with the external server. Alternative sources and means may be used to obtain the user frequency data. Each of the known solving procedures is then assigned a frequency rank based on the usage frequency data. Low frequency solving procedures are assigned a higher rank, and high frequency solving procedures are assigned a lower rank. The creativity score is proportionately adjusted according to the frequency rank of the user solving procedure, referring to FIG. 10, thus rewarding solutions which are lower in frequency.

In one embodiment of the present invention, a low frequency solving procedure is assigned a higher rank as this indicates thinking outside the norm. Complimentary, a high frequency solving procedure is assigned a lower rank. Equipped with this information, the creativity score of the arbitrary account is proportionately adjusted according to the frequency rank of the user solving procedure. A more novel solving procedure, a low frequency solving procedure, yields in a higher creativity score; a more common solving procedure, a high frequency solving procedure, yields in a lower creativity score.

In an alternative embodiment, the administrative entity assigns a weight to each of the known solving procedures, defining which solving procedure requires a more creative mindset. The weight of the known solving procedure is then used to determine the creativity score of each of the plurality of user accounts.

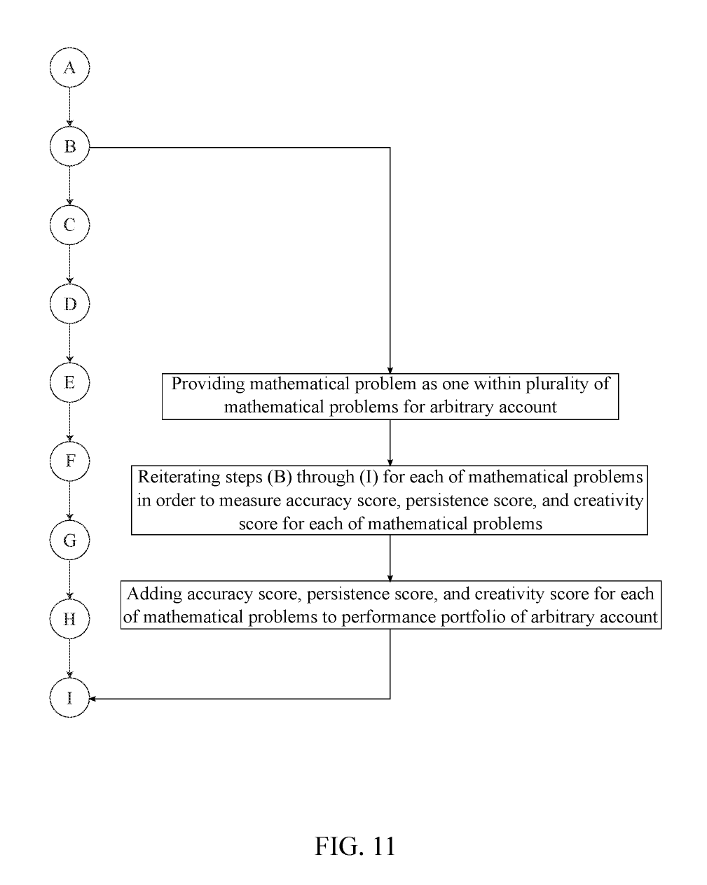

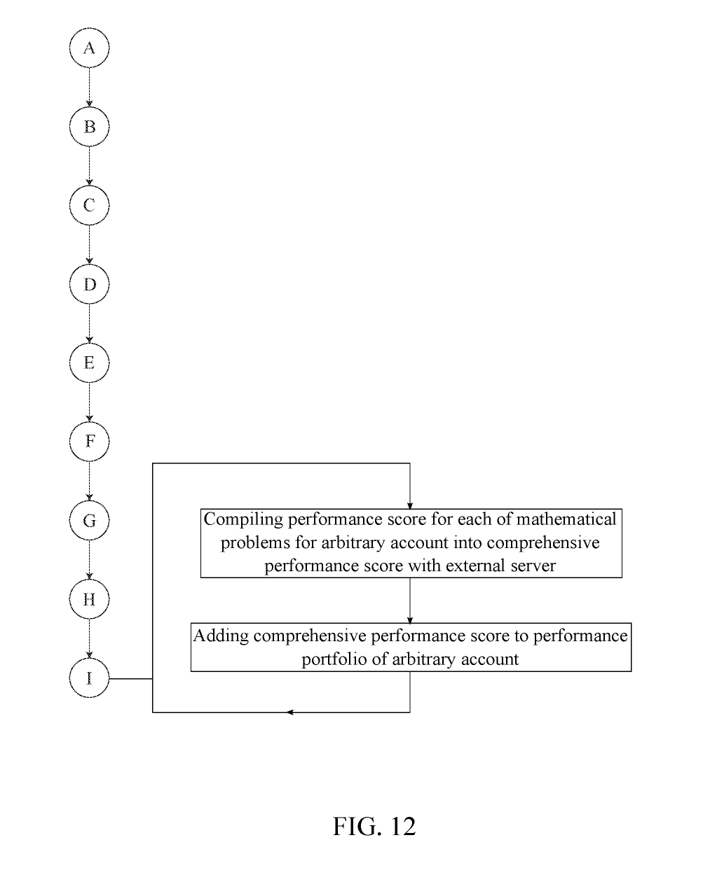

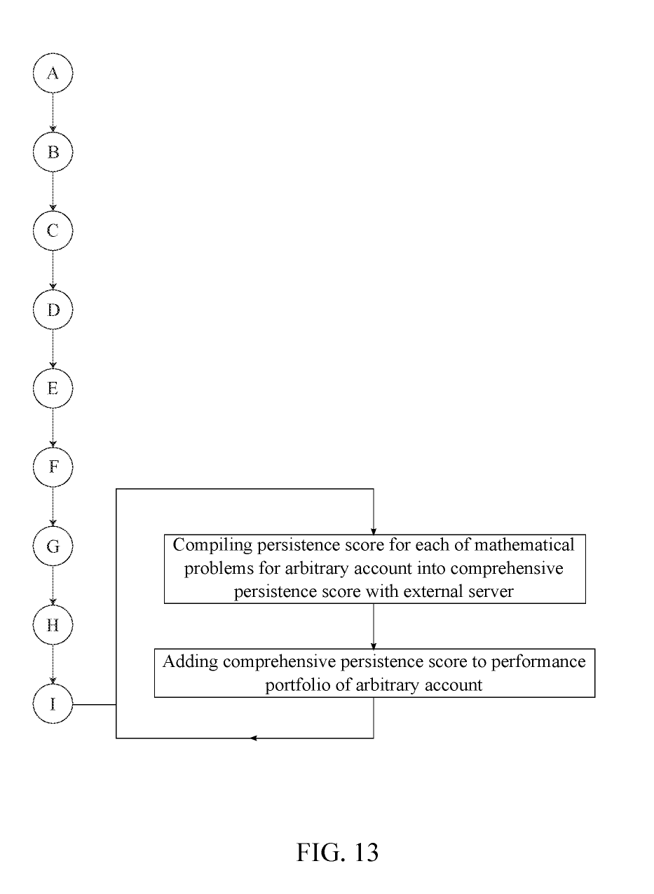

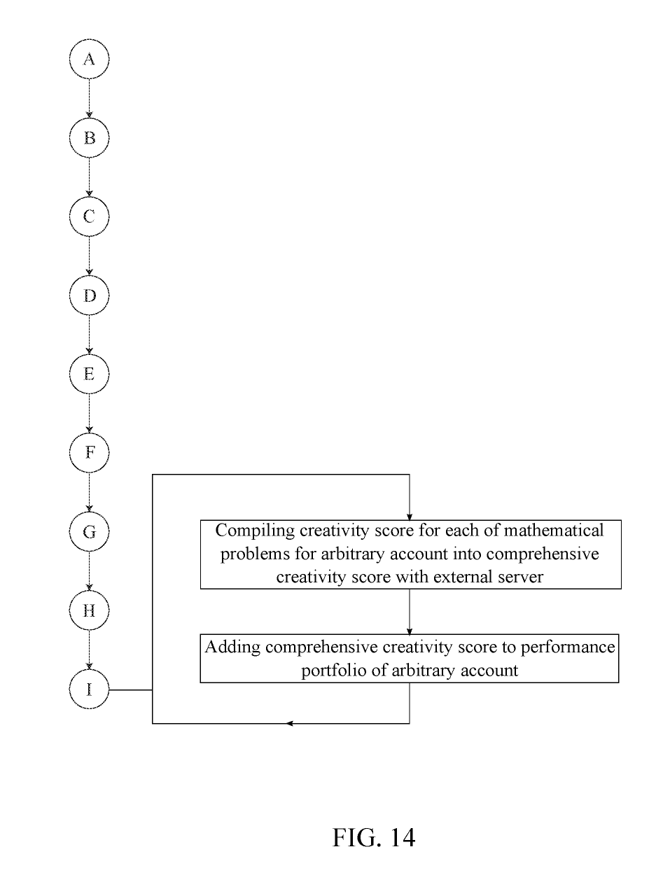

Referring to FIG. 11, in order to obtain a more significant reflection of the cognitive ability of the arbitrary account, the aforementioned processes are repeated for each of the plurality of mathematical problems. More specifically, Step B through I are reiterated for each of the mathematical problems in order to measure the accuracy score, the persistence score, and the creativity score for each of the mathematical problems. The accuracy score, the persistence score, and the creativity score for each of the mathematical problems are then added to the performance portfolio of the arbitrary account. This provides a plethora of data which reflects the mathematical cognitive ability of the arbitrary account. In order to consolidate and draw conclusions from this data, the creativity score, the persistence score, and the performance score are adjusted to reflect an overall score, seen in FIG. 12, FIG. 13, and FIG. 14. More specifically, the performance score for each of the mathematical problems for the arbitrary account is compiled into a comprehensive performance score with external server. Similarly, the persistence score for each of the mathematical problems for the arbitrary account is compiled into a comprehensive persistence score with external server. Furthermore, the creativity score for each of the mathematical problems for the arbitrary account is compiled into a comprehensive creativity score with external server. The comprehensive performance score, the comprehensive persistence score, and the creativity comprehensive score are then compiled into an overall mathematical intelligence score added to the performance portfolio of the arbitrary account for the arbitrary account to access and view. Each of the comprehensive scores are preferably displayed as a percentage. A variety of means may be utilized in order to yield the overall mathematical intelligence score. One way includes adding the three comprehensive scores together. Another option includes assigning a weight value to each score and adding them together afterwards. In yet another embodiment, the present invention only shows the maximum of the three scores.

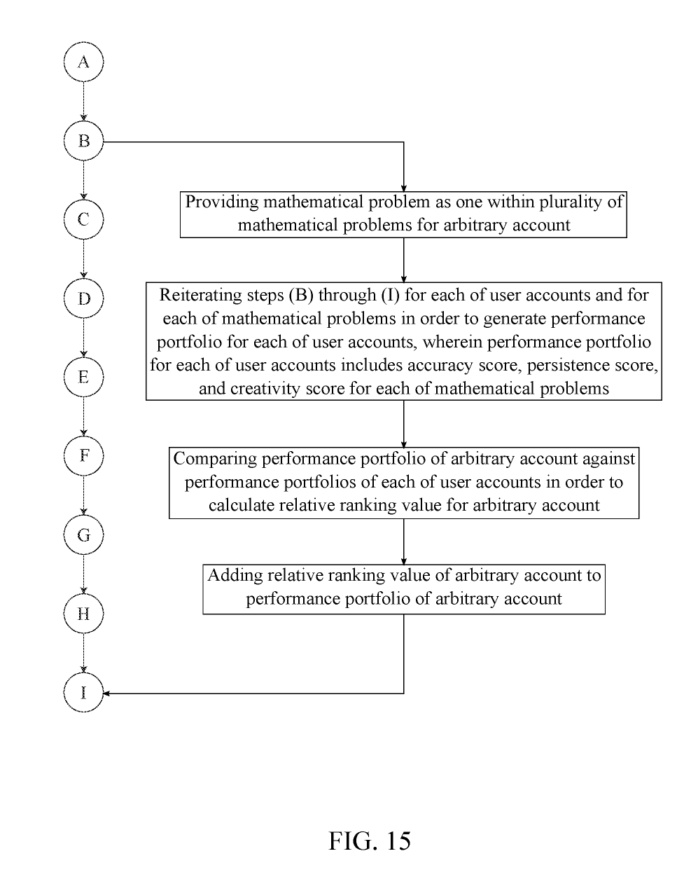

Referring to FIG. 15, in addition to providing personal performance metrics to the arbitrary account, the present invention also provides the arbitrary account with his or her relative standing in relation to the plurality of user accounts. This is achieved by reiterating Step B through Step I for each of the user accounts and for each of the mathematical problems in order to generate the performance portfolio for each of the user accounts; wherein the performance portfolio for each of the user accounts includes the accuracy score, the persistence score, and the creativity score for each of the mathematical problems. Furthermore, the performance portfolio for each of the user accounts also includes the comprehensive performance score, the comprehensive persistence score, the comprehensive creative score, and the overall mathematical intelligence score for the arbitrary account.

The external server then compares the performance portfolio of the arbitrary account against the performance portfolio of each of the user accounts in order to calculate a relative ranking value for the arbitrary account. In particular, the present invention calculates the relative ranking value of the arbitrary account in relation to any individual constituents, or any combination of the constituents, of the performance portfolio. The relative ranking value is then added to the performance portfolio of the arbitrary account and may be displayed through a variety of means including, but not limited to, graphs, charts, simple numbers, percentages, or other traditional means. It is preferred that the arbitrary account is provided with all the information within the performance portfolio, starting with a broad overview of his or her performance to the individual score for each of the mathematical problems; this allows for the arbitrary account to see what type of mathematical problems he or she needs to work on.

In alternative embodiments, the method of the present invention may be applied to alternative fields of study such as biology, physics, engineering, and other similar fields.

Although the invention has been explained in relation to its preferred embodiment, it is to be understood that many other possible modifications and variations can be made without departing from the spirit and scope of the invention as hereinafter claimed.

What is claimed is:

1. A method for numerically measuring mathematical fitness comprises the steps of:
(A) providing a plurality of user accounts, wherein each of the user accounts is associated to a corresponding personal computing (PC) device;
(B) providing a plurality of solutions associated to a mathematical problem, wherein the solutions and the mathematical problem are stored on an external server;
(C) providing usage frequency data for a plurality of known solving procedures, wherein the usage frequency data is stored on the external server;
(D) prompting an arbitrary account from the plurality of user accounts to solve the mathematical problem through the corresponding PC device;
(E) receiving answering data for the arbitrary account through the corresponding PC device;
(F) comparing the answering data against each of the plurality of solutions with the external server in order to identify a matching solution amongst the plurality of solutions;
(G) monitoring steps (D) and (E) with the external server in order to measure a performance score and a persistence score for the arbitrary account and in order to record a user solving procedure for the arbitrary account;
(H) comparing the user solving procedure of the arbitrary account to the usage frequency data with the external server in order to measure a creativity score for the arbitrary account; and
(I) enabling the arbitrary account to view a performance portfolio through PC device, wherein the performance portfolio includes the accuracy score, the persistence score, and the creativity score.

2. The method for numerically measuring mathematical fitness as claimed in claim 1 comprises the steps of:
increasing the performance score of the arbitrary account, if the matching solution is identified during step (F); and
decreasing the performance score of the arbitrary account, if the matching solution is not identified during step (F).

3. The method for numerically measuring mathematical fitness as claimed in claim 1 comprises the steps of:
providing each of the known solving procedures with a plurality of known steps;
providing the user solving procedure with a plurality of recorded steps;
comparing the recorded steps to the known steps for each of the known solving procedures in order to assess a similarity degree for each of the known solving procedures, wherein the similarity degree proportionately depends on a number of shared steps between the recorded steps and the known steps for each of the known solving procedures;
designating a most-similar procedure amongst the known solving procedure based on the similarity degree for each of the known solving procedures; and
proportionately adjusting the performance score of the arbitrary account according to the similarity degree of the most-similar procedure.

4. The method for numerically measuring mathematical fitness as claimed in claim 1 comprises the steps of:
wherein the matching solution is identified during step (F);
assigning an efficiency rank based on a total number of steps for each of the known solving procedures; and
proportionately adjusting the performance score of the arbitrary account according to the efficiency rank of the user solving procedure.

5. The method for numerically measuring mathematical fitness as claimed in claim 1 comprises the steps of:
(J) sending an incorrect notification to the arbitrary account through the corresponding PC device after step (F), if the matching solution is not identified during step (F);
(K) prompting the arbitrary account to resolve the mathematical problem through the corresponding PC device;
(L) receiving new data for the arbitrary account through the corresponding PC device;
(M) repeating step (F) with the new data as the answering data;
(N) repeating steps (J) through (M) until the matching solution is identified during step (F); and
(O) monitoring steps (J) through (N) in order assess inputs for the persistence score.

6. The method for numerically measuring mathematical fitness as claimed in claim 5 comprises the steps of:
providing a plurality of repetitions for steps (J) through (N);
logging a total repetition number for the plurality of repetitions; and
proportionately increasing the persistence score based on the total repetition number.

7. The method for numerically measuring mathematical fitness as claimed in claim 5 comprises the steps of:
providing a plurality of repetitions for steps (J) through (N);
logging a total time duration for each of the plurality of repetitions; and
proportionately increasing the persistence score based on the total time duration.

8. The method for numerically measuring mathematical fitness as claimed in claim 1 comprises the steps of:
reiterating steps (B) through (I) for each of the user accounts in order to generate the performance portfolio for each of the user accounts; and
updating the usage frequency data with the user solving procedure for each of the user accounts with the external server.

9. The method for numerically measuring mathematical fitness as claimed in claim 1 comprises the steps of:
providing a frequency rank for each of the known solving procedures based on the usage frequency data; and
proportionately adjusting the creativity score of the arbitrary account according to the frequency rank of the user solving procedure.

10. The method for numerically measuring mathematical fitness as claimed in claim 1 comprises the steps of:
providing the mathematical problem as one within a plurality of mathematical problems for the arbitrary account;
reiterating steps (B) through (I) for each of the mathematical problems in order to measure the accuracy score, the persistence score, and the creativity score for each of the mathematical problems; and
adding the accuracy score, the persistence score, and the creativity score for each of the mathematical problems to the performance portfolio of the arbitrary account.

11. The method for numerically measuring mathematical fitness as claimed in claim 10 comprises the steps of:
compiling the performance score for each of the mathematical problems for the arbitrary account into a comprehensive performance score with the external server; and
adding the comprehensive performance score to the performance portfolio of the arbitrary account.

12. The method for numerically measuring mathematical fitness as claimed in claim 10 comprises the steps of:
compiling the persistence score for each of the mathematical problems for the arbitrary account into a comprehensive persistence score with the external server; and
adding the comprehensive persistence score to the performance portfolio of the arbitrary account.

13. The method for numerically measuring mathematical fitness as claimed in claim 10 comprises the steps of:
compiling the creativity score for each of the mathematical problems for the arbitrary account into a comprehensive creativity score with the external server; and
adding the comprehensive creativity score to the performance portfolio of the arbitrary account.

14. The method for numerically measuring mathematical fitness as claimed in claim 10 comprises the steps of:
providing a comprehensive performance score, a comprehensive persistence score, and a comprehensive creativity score for the arbitrary account; and
compiling the comprehensive performance score, the comprehensive persistence score, and the comprehensive creativity score into an overall mathematical intelligence score.

15. The method for numerically measuring mathematical fitness as claimed in claim 1, wherein a mathematical problem is an open-ended problem or puzzle.

16. The method for numerically measuring mathematical fitness as claimed in claim 10 comprises the steps of:
providing the mathematical problem as one within a plurality of mathematical problems for the arbitrary account;
reiterating steps (B) through (I) for each of the user accounts and for each of the mathematical problems in order to generate the performance portfolio for each of the user accounts, wherein the performance portfolio for each of the user accounts includes the accuracy score, the persistence score, and the creativity score for each of the mathematical problems;
comparing the performance portfolio of the arbitrary account against the performance portfolios of each of the user accounts in order to calculate a relative ranking value for the arbitrary account; and
adding the relative ranking value of the arbitrary account to the performance portfolio of the arbitrary account.
